(19) United States
(12) Patent Application Publication
(10) Pub. No.: US 2026/0183714 A1
(43) Pub. Date: Jul. 2, 2026

(54) CONTINUOUS TANGENTIAL FLOW FILTRATION SYSTEM

(71) Applicant: ELI LILLY AND COMPANY, Indianapolis, IN (US)

(72) Inventors: Yamei CHEN, Carmel, IN (US); Cyrus Alonzo FISHER, Indianapolis, IN (US); John Fletcher MOOMAW, Indianapolis, IN (US); Benjamin Lewis PATERSON, Noblesville, IN (US); Vincent Paul SALUPO, Indianapolis, IN (US); Katerina Marie WILKSTEIN, Indianapolis, IN (US)

(21) Appl. No.: 18/868,154

(22) PCT Filed: May 24, 2023
(86) PCT No.: PCT/US2023/067381

§ 371 Date: Nov. 21, 2024

Related U.S. Application Data
(60) Provisional application No. 63/345,942, filed on May 26, 2022.

(51) Int. Cl. B01D 61/14; B01D 61/22

(52) U.S. Cl. CPC B01D 61/145; B01D 61/22; B01D 2311/14; B01D 2313/16; B01D 2313/50; B01D 2315/10

(57) ABSTRACT

Tangential flow filtration systems and, more specifically, continuous tangential flow filtration (“cTFF”) systems comprised of single-pass modules are disclosed herein. Each single-pass module is configured to transition from a first process configuration to a second process configuration and/or operate under both the first process configuration and the second process configuration for customization of the cTFF system. Each of the modules has at least one break tank for regulation of flow and pressure throughout the module and, on a larger scale, the cTFF system.

### FIELD OF THE DISCLOSURE

The present disclosure relates to tangential flow filtration systems and, more specifically, to continuous tangential flow filtration (“cTFF”) systems comprised of single-pass modules having more than one process configuration and at least one break tank for flow and pressure control.

### BACKGROUND OF THE DISCLOSURE

Conventional pharma and biopharma manufacturing processes require a series of discrete batch operations arranged in a downstream configuration. For example, conventional systems may include instances of column chromatography, viral inactivation, viral filtration, tangential flow filtration, final filtration, and storage and shipping. Each of these operations may further require their own subset of operations. For example, a conventional way of completing tangential flow filtration is via batch tangential flow filtration (bTFF), which requires recirculation of feed material through the same filter multiple times. This is done to either increase a concentration of a solute of interest within a solution and/or to achieve a desired solution composition through diafiltration, in which a solute of interest is transitioned from a starting solution matrix into an exchange buffer. Such processes require several recirculation passes and can result in inefficiency of the system.

Continuous tangential flow filtration strategies may include using single-pass tangential flow filtration (“spTFF”) as a concentration operation and counter-current buffer exchange tangential flow filtration (“CCBE-TFF”) as a diafiltration operation, which enables continuous tangential flow filtration that can be used to accomplish the same processing outcomes as bTFF. For example, spTFF can accomplish the same desired concentration in a single pass across a filter rather than requiring several, and even hundreds, of passes across the filter. With addition of multiple continuous concentration steps in series and collated with in-line dilutions, spTFF can also be used for CCBE-TFF. However, CCBE-TFF requires multiple stages to improve efficiency, where the feed stream is continuously fed into the system and the retentate is continuously collected at the outlet through a series of dilution and concentration stages. The diafiltration buffer is supplied at the final diafiltration stage. Permeate from the final stage then serves as the diafilterant for the preceding stage, resulting in a flow “counter-current” to the feed stream. However, CCBE-TFF processes come with their own set of challenges, including complex process control, an increased number of necessary pumps and other instrumentation, and a greater requirement for surface area relative to traditional bTFF systems. Further, the requirement of serial stages presents process control challenges, including, but not limited to, unstable flow rates, system over-pressure, undesired mixing, tightly coupled flow control loops between stages, and complex start-up and shut down procedures, which further complicates situations requiring a disturbance response, where restart of the system is necessary, resulting in further inefficiencies.

### SUMMARY

The present disclosure relates to tangential flow filtration systems and, more specifically, to continuous tangential flow filtration (“cTFF”) systems comprised of single-pass modules configured to transition from a first process configuration to a second process configuration and/or operate under both the first process configuration and the second process configuration for customization of the cTFF system. Each of the modules has at least one break tank for regulation of flow and pressure throughout the module and, on a larger scale, the cTFF system.

In a first aspect of the disclosure, a tangential flow filtration module is described. The module comprises a flow supply comprising a module exchange buffer supply and a module feed supply; a feed break tank positioned downstream of the flow supply, the feed break tank including a powered agitator; and a first filter positioned downstream of the feed break tank.

In another aspect of the disclosure, a tangential flow filtration module is described. The module comprises a flow supply comprising a module exchange buffer supply and a module feed supply; a filter positioned downstream of the flow supply and having two outputs, including a permeate output and a retentate output; and a permeate break tank positioned downstream of the filter and supplied by the permeate output of the filter.

In yet another aspect of the disclosure, a tangential flow filtration system is described. The tangential flow filtration system comprises a plurality of individual modules, each of said individual modules configured to perform a process associated with tangential flow filtration, wherein each individual module includes a plurality of valves and a control system. Actuation of the plurality of valves is configured to alter a flow path of the corresponding individual module. The control system is configured to calculate a current stage removal factor for the individual module and automatically operate the plurality of valves to alter the flow path so that the current stage removal factor for the individual module approaches a target stage removal factor. The current stage removal factor is a ratio between any two of a permeate flow rate, a feed flow rate, and a retentate flow rate for the individual module.

In another aspect of the disclosure, a tangential flow filtration system is described. The system comprises a plurality of modules, each module comprising a module flow supply; a filter positioned downstream of the module flow supply; and at least one of a feed break tank positioned between the module flow supply and the filter and a permeate break tank positioned downstream of the filter.

In various aspects of the disclosure, the module may further comprise a feed pump positioned between the feed break tank and the first filter. The feed pump may be configured to control a flow rate of a flow between the feed break tank and the first filter.

In various aspects of the disclosure, operation of the powered agitator is configured to create a homogenous solution.

In various aspects of the disclosure, the feed break tank may define an air gap.

In various aspects of the disclosure, the feed break tank may define a vent in fluid communication with ambient pressure.

In various aspects of the disclosure, a permeate break tank may be positioned downstream of the first filter.

In various aspects of the disclosure, the module exchange buffer supply may be comprised of permeate of a second filter positioned downstream of the first filter, a feed supply of the second filter comprising retentate of the first filter.

In various aspects of the disclosure, the module feed supply is comprised of retentate of a third filter positioned upstream of the first filter.

In various aspects of the disclosure, a feed break tank may be positioned between the flow supply and the filter.

In various aspects of the disclosure, an interior of the permeate break tank may define an air gap.

In various aspects of the disclosure, the permeate break tank may include a vent in fluid communication with ambient pressure.

In various aspects of the disclosure, a valve may be positioned between the first filter and the permeate break tank. The valve may be configured to control permeate pressure on the permeate side of the first filter.

In various aspects of the disclosure, the permeate break tank may supply a second filter positioned upstream of the feed supply. The feed supply may be comprised of retentate of the second filter.

In various aspects of the disclosure, the module exchange buffer supply may be comprised of permeate of a third filter positioned downstream of the first filter, a feed supply of the third filter comprising retentate of the first filter.

In various aspects of the disclosure, the module may comprise at least one valve, wherein operation of the valve is configured to change a configuration of the tangential flow filtration module from a first flow path configuration to a second flow path configuration or a configuration of the tangential flow filtration module from the second flow path configuration to a first flow path configuration. The first flow configuration may be a counter-current buffer exchange flow path configuration. The second flow configuration may be a single-pass tangential flow filtration flow path configuration.

In various aspects of the disclosure, the plurality of individual modules may include at least five modules.

In various aspects of the disclosure, a last individual module of the plurality of individual modules may have a different target stage removal factor than at least one other individual module of the plurality of individual modules.

In various aspects of the disclosure, the control system may be configured to maintain the tangential flow filtration system in a steady state in which the current stage removal factor approaches the target stage removal factor. The system may be configured to allow a user to adjust, when the tangential flow filtration system is in the steady state, at least one valve of the plurality of valves in a way that causes the current stage removal factor to diverge from the target stage removal factor. The control system may be configured to automatically operate remaining valves of the plurality of valves to compensate for the user's adjustment such that the current stage removal factor again approaches the target stage removal factor after the user's adjustment. Each of the plurality of individual modules may comprise a feed break tank positioned downstream of a flow supply and upstream of the filter for the individual module and a permeate break tank positioned downstream of the filter. The flow supply may comprise a module feed supply and a module exchange buffer supply. A first flow rate output of the feed break tank and a second flow rate output of the permeate break tank may be individually adjustable during operation of the tangential flow filtration system. The control system may be configured to maintain the tangential flow filtration system in a steady state by automatically maintaining a substantially constant stage removal factor during adjustment of either of the first flow rate output or the second flow rate output. The control system may be further configured to maintain a constant level within the feed break tank and a constant level within the permeate break tank.

In various aspects of the disclosure, each module may have at least one of a first configuration corresponding to a single-pass tangential flow filtration (“spTFF”) process, a second configuration corresponding to a counter-current buffer exchange tangential flow filtration (“CCBE-TFF”) process, and a third configuration corresponding to a combined spTFF and CCBE-TFF process. Each module of the plurality of modules may include a plurality of valves so that each module of the plurality of modules is capable of selectively switching form the first configuration to at least one of the second configuration and the third configuration, selectively switching from the second configuration to at least one of the first configuration and the third configuration, and selectively switching form the third configuration to at least one of the first configuration and the second configuration. A first module of the plurality of modules may be in the first configuration and a second module of the plurality of modules may be in the second configuration. A first plurality of modules including the first module may be in the first configuration and a second plurality of modules including the second module may be in the second configuration. A last module of the plurality of modules may be operated in the third configuration. At least some permeate from the last module may be supplied to a module exchange buffer supply for another module upstream to the last module, and at least some permeate from the last module may be sent to waste.

In various aspects of the disclosure, each module of the plurality of modules may include a retentate flow path and a permeate flow path. The permeate break tank may be positioned along the permeate flow path.

In various aspects of the disclosure, the system may comprise at least five modules.

In various aspects of the disclosure, a first module of the plurality of modules includes a system feed supply. A last module of the plurality of modules includes a system buffer exchange supply.

In various aspects of the disclosure, the system may be configured to operate as a diafiltration system that transfers a solute of interest from within a feed supply from a starting solution matrix into an exchange buffer. The system may be configured to flush the filter of each module with the exchange buffer before starting to filter the feed supply.

In various aspects of the disclosure, the system may be configured to compensate for outputting product during system start-up with a concentration that is lower than process requirements by outputting product during steady-state with a concentration that is higher than process requirements, such that a mixture of product output during start-up and product output during steady-state has a concentration that meets the process requirements.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above-mentioned and other features and advantages of this disclosure, and the manner of attaining them, will become more apparent and will be better understood by reference to the following description of embodiments of the invention taken in conjunction with the accompanying drawings, wherein:

FIG. 1 is a diagrammatic illustration of a continuous tangential flow filtration (“cTFF”) system comprised of substantially similar modules;

FIG. 2 is a diagrammatic illustration of a module of the cTFF system of FIG. 1;

FIG. 3 is a series of graphical illustrations of various monitoring parameters for assessing a steady-state operation of experimental cTFF system modules conducting CCBE-TFF or buffer exchange processes;

FIG. 4 is a series of graphical illustrations of various monitoring parameters for assessing a steady-state operation of an experimental cTFF module conducting CCBE-TFF and spTFF secondary concentration processes simultaneously; and

FIG. 5 is a graphical illustration of a region of pressure dependence relative to permeate flux and retentate concentration and a region of less pressure dependence relative to permeate flux and retentate concentration.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

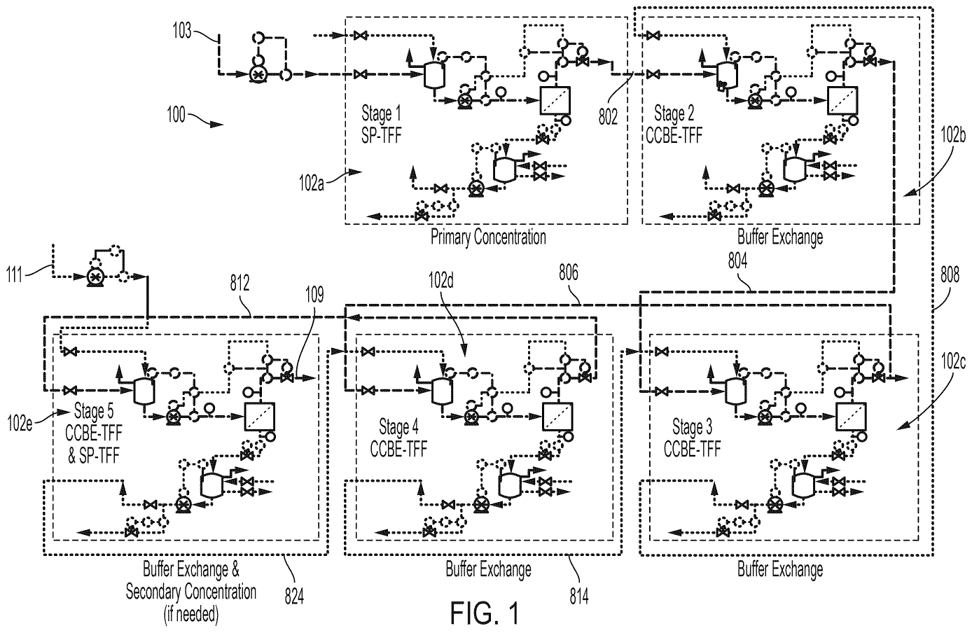

FIG. 1 provides a diagrammatic illustration of a fully integrated continuous tangential flow filtration (“cTFF”) system 100. The cTFF system 100 accepts as input a system feed supply 103 and outputs a finished system product 109. Optionally, the cTFF system 100 also accepts as input a system exchange buffer supply 111. The system feed supply 103 may include a solute of interest, such as a monoclonal antibody (mAB), suspended within a starting solution matrix. The cTFF system 100 may operate to increase a concentration of the solute of interest within the finished system product 109. The cTFF system 100 may operate as a diafiltration system, in which the solute of interest is transferred from the starting solution matrix into the exchange buffer. When operated as a diafiltration system, the finished system product 109 may comprise the solute of interest suspended within the exchange buffer supplied at 109, instead of the starting solution matrix. In some embodiments, the cTFF system may operate to both transfer the solute of interest to the exchange buffer, as well as to increase the concentration of the solute of interest in the finished system product.

The cTFF system 100 may include a plurality of modules 102, wherein each module 102 has substantially the same operating structure as the remaining modules described further herein, including a number of valves and/or other instrumentation allowing for a change in flow path configuration for the carrying out of various processes. As illustrated, the cTFF system 100 includes five modules 102; however, other embodiments may include a greater or a fewer number of modules 102 to carry out the processes as described.

Each of the modules 102 may be configured for performance of a tangential flow filtration process. As illustrated, a first module 102a is configured for performing a primary concentration function using single-pass tangential flow filtration (“spTFF”); a final module 102e is configured for performing a secondary concentration function using spTFF, if needed, in tandem with a counter-current buffer exchange tangential flow filtration (“CCBE-TFF”) process; and a second module 102b, a third module 102c, and a fourth module 102d, are each configured for performing CCBE-TFF. As noted above, each module 102 has substantially the same operating structure. Each module 102 may be configured to complete different processes by closing or opening certain on or off valves within the module 102. As such, each module 102 may be readily operated in either configuration. Accordingly, the cTFF system 100 can be arranged with any number of modules as desired, wherein each module 102 may be configured for the same or different processes as desired.

For example, in other embodiments, the cTFF system 100 may include six modules 102, where the second module, the third module, the fourth module, and the fifth module are each configured for performing CCBE-TFF, while the sixth module is configured for performing a secondary concentration function using spTFF. Other embodiments are available which allow for the optimization of the system 100 for a specific process objective by using a fewer or greater number of modules 102 and configuring each module for a process accordingly (e.g., spTFF, CCBE-TFF, a combination of spTFF and CCBE-TFF, or other processes as desired).

The connections between each module 102 are also illustrated in FIG. 1. For example, a retentate output of the first module 102a, or the primary concentration stage using an spTFF process, may provide a feed or retentate supply to the second module 102b along pathway 802 as described further herein. A retentate output of the second module 102b, or a first buffer exchange stage, may provide a feed or retentate supply to the third module 102c along pathway 804. A retentate output of the third module 102c, or a second buffer exchange stage, may provide a feed or retentate supply to the fourth module 102d along pathway 806, while a permeate output of the third module 102c may provide a permeate or diafiltration buffer supply to the second module 102b along pathway 808.

The retentate output of the fourth module 102d, or a third buffer exchange stage, may provide a feed or retentate supply to the fifth module 102e along pathway 812, while a permeate output of the fourth module 102d may provide a permeate or diafiltration buffer supply to the third module 102c along pathway 814. A retentate output of the fifth module 102e, which may serve as a fourth buffer exchange stage and/or a secondary concentration stage, is collected as product, while a permeate output of the fifth module 102e provides a permeate supply to the fourth module 102d along pathway 824. The flow rate control of each pathway is discussed further herein.

The system feed supply 103 may be supplied to the first module 102a. The final product 109 may be collected from the last module, i.e., fifth module 102e. When the cTFF system is operated as a diafiltration system, exchange buffer may also be provided to the final module, i.e., fifth module 102e, as described in further detail below.

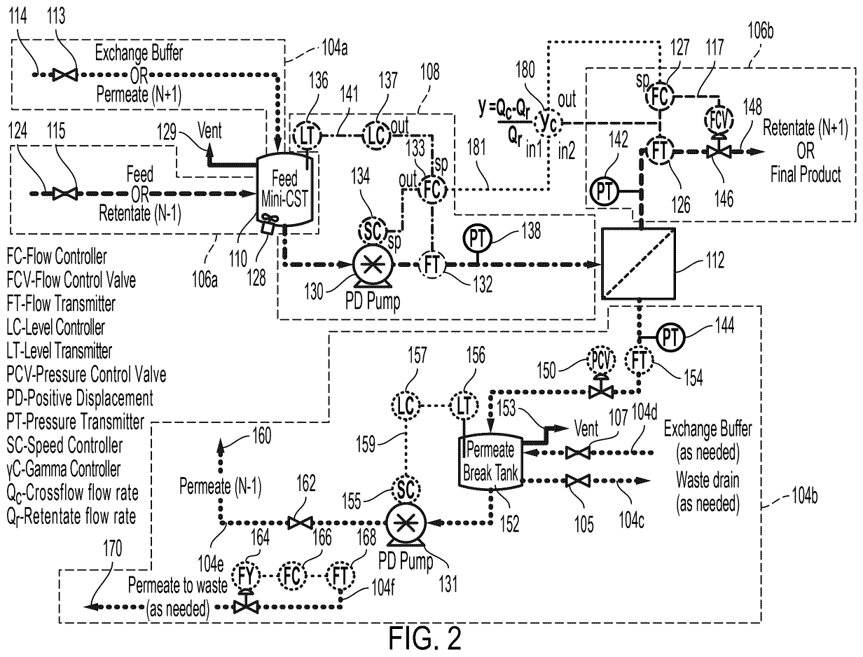

FIG. 2 is a diagrammatic illustration of a module 102, its components, and the connections therebetween. Flow path 104 (including flow paths 104a and 104b, which may also include flow paths 104c, 104d, 104e, and/or 104f) illustrates a permeate pathway, flow path 106 (including flow paths 106a and 106b) illustrates a retentate and/or feed pathway, and flow path 108 illustrates a feed pathway between a first break tank, or 110, and a filter 112, as further discussed herein. For clarity, in both FIGS. 1 and 2, permeate pathways are shown by dotted lines, retentate and/or feed pathways are shown by dashed lines, while pathways between break tanks and filters are shown by dash-dot-dash lines. Each of flow paths 104, 106, and 108 may be controlled as further disclosed herein to form at least one of a first flow path configuration associated with an spTFF process and/or a second flow path configuration associated with a CCBE-TFF process so that the first flow path configuration and the second flow path configuration may be active simultaneously or exclusively. In other words, the module 102 may be configured to perform an spTFF process and a CCBE-TFF process simultaneously or exclusively.

A first portion of flow path 104, flow path 104a, may start at each module 102 with a diafiltration buffer or, interchangeably, permeate supply at a first input 114, wherein the supply source for the module 102 may be dependent on the positioning of the module 102 within the cTFF system 100 (FIG. 1). Where appropriate, the permeate supply or diafiltration buffer provided at the first input 114 may be provided by a downstream module 102 as described above in relation to the cTFF system 100. First input 114 may be considered a module exchange buffer supply. Operation of a flow valve, e.g., flow control valve 113, may prohibit or allow permeate supply flow or diafiltration buffer supply flow into flow path 104a as desired for process configuration of the module 102. For example, operation of the flow control valve 113 may further facilitate control of the amount of permeate supply or diafiltration buffer entering flow path 104a to maintain a stable system 100 (FIG. 1) as described further herein. In other words, the flow control valve 113 may facilitate control of the flow rate of permeate supply or diafiltration buffer into the module 102 as required by the status of the module 102 and/or the system 100 (FIG. 1). When the flow control valve 113 is open and the flow path 104a is active, the diafiltration buffer or permeate supply may enter the feed side break tank 110, ending flow path 104a. The flow rate of diafiltration buffer or permeate supply through the flow control valve 113 may relate in part to the degree at which the flow control valve 113 is opened. For example, a fully opened valve may allow a maximum flow rate, while a half-opened valve may allow about a 50% flow rate. Varying degrees of openness of the flow control valve 113 and corresponding flow rates may be used as desired for purposes of module operation.

A first portion of flow path 106, flow path 106a, may start at each module 102 with a feed supply or, interchangeably, retentate supply at a second input 124, wherein the supply source for the module 102 may be dependent on the positioning of the module 102 within the cTFF system 100 (FIG. 1). Where appropriate, the retentate supply or feed supply provided at the second input 124 may be provided by an upstream module 102 as described above in relation to the cTFF system 100. Second input 124 may be considered a module feed supply. Operation of a flow valve, e.g., flow control valve 115, may prohibit or allow retentate supply flow or feed supply flow into flow path 106a as desired for process configuration of the module 102. For example, operation of the flow control valve 115 may further facilitate control of the amount of retentate supply or feed supply entering flow path 106a to maintain a stable system 100 (FIG. 1) as described further herein. In other words, the flow control valve 115 may facilitate control of the flow rate of retentate supply or feed supply into the module 102 as required by the status of the module 102 and/or the system 100 (FIG. 1). When the flow control valve 115 is open and flow path 106a is active, the retentate supply or feed supply enters the feed side break tank 100, ending flow path 106a. The flow rate of retentate supply or feed supply through the flow control valve 115 may relate in part to the degree at which the flow control valve 115 is opened. For example, a fully opened valve may allow a maximum flow rate, while a half-opened valve may allow about a 50% flow rate. Varying degrees of openness of the valve 115 and corresponding flow rates may be used as desired for purposes of module operation.

The feed break tank 110 may begin flow path 108. The feed break tank 110 may receive fluid flow from at least one of flow path 104a and flow path 106a. A powered agitator 128, such as an impeller, may be contained within the feed break tank 110 to mix the fluid to ensure a homogenous stream. The feed break tank 110 may include a vent 129 in communication with ambient pressure to allow pressure to return to and remain at ambient pressure between modules 102. The vent 129 facilitates the ability of each module 102 to utilize the full pressure range of the filter 112, mitigating any pressure cascade that may otherwise result throughout the cTFF system 100 (FIG. 1).

For example, during CCBE processes, the permeate from each stage may be re-injected into the feed stream of the preceding stage, similar to the flow paths of permeate described above in reference to FIG. 1. Generally, in certain embodiments not including a feed break tank 110, the exit pressure of the permeate may be higher than the feed pressure of the preceding stage, resulting in a pressure cascade where the pressure at the final stage is the highest while the pressure at the initial stage is the lowest. The maximum pressure of the system may therefore be constrained by the pressure rating of the system. That maximum pressure of the system must be shared across all stages in the system. An increase in the number of stages may improve exchange efficiency which reduces the buffer requirements; however, with a greater number of stages, the maximum pressure of the system must be shared across a greater number of stages, resulting in less pressure available to drive permeation at each individual stage, thus limiting the effectiveness of each stage. By including feed break tank 110 and using vent 129 to stabilize the pressure within the module 102, the pressure cascade may be mitigated.

Ideally, the retention time within the feed break tank 110 is relatively short, e.g., about 30-120 seconds. The relatively short residence time within feed break tank 110 may minimize the system time constant required to reach steady-state operation as described herein, including start-up time, shutdown time, and response time to disturbances. Properly sized break tanks may provide adequate capacity to absorb disturbances while maintaining a reasonable hold up volume. A greater or shorter retention time within the feed break tank 110 may also be considered.

A pump 130, such as a positive displacement pump, may be positioned downstream of the feed break tank 110 to facilitate flow of the homogenous mixture from the feed break tank 110 to the filter 112. A flow transmitter 132 may be positioned downstream of the pump 130 to measure the flow rate of the homogenous mixture from the feed break tank 110 to the filter 112. The flow transmitter 132 may be in operable communication with a flow controller 133, which is configured to control the flow rate according to the needed level adjustments within feed break tank 110 as communicated by a level transmitter 136 and level controller 137 as described below. The flow controller 133 is in operable communication with a speed controller 134 of the pump 130 as shown by process control loop 141, so that the speed of the pump 130 may be adjusted as desired per the measured flow rate by the flow transmitter 132 and flow controller 133. As used herein, process control loop 141 refers to all the dashed process control connections that interconnect level transmitter 136, level controller 137, flow controller 133, speed controller 134, and flow transmitter 132 as shown in FIG. 2.

The speed controller 134 may further be operably coupled to a level transmitter 136 and level controller 137, as shown by process control loop 141, which may be configured to work in tandem to measure and control the amount of mixture present in the feed break tank 110 to maintain said amount within a threshold range, ensuring the feed break tank 110 includes an air gap facilitating the control of pressure within the feed break tank 110 as described above. The air gap may further allow the break tank to absorb flow control disturbances and decouple flow control between the modules 102. The speed controller 134 may adjust the speed of the pump 130 as desired per the measurements taken and provided by the level transmitter to keep the mixture level of the feed break tank 110 within the desired level as determined by the level controller 137 and flow controller 133 as described above. For example, if the level of mixture in the feed break tank 110 exceeds a ceiling threshold amount, the pump 130 may increase flow rate from the feed break tank 110 into the remaining flow path 108 and through the module 102 as described further herein. If the level of mixture in the feed break tank 110 drops below a floor threshold amount, the pump 130 may decrease the flow rate from the feed break tank 110, thus allowing the feed break tank 110 to refill. In other embodiments, a weight transmitter (not shown) may be operably coupled to the feed break tank 110 to measure the contents of the feed break tank 110 via weight, in addition to or instead of measuring the contents via level. The weight transmitter and the level transmitter may work in tandem or separately to measure the contents of the feed break tank 110 in various embodiments.

The homogenous mixture may be pumped from the feed break tank 110 to the filter 112 as described above. A first pressure transmitter 138 may be positioned between the pump 130 and the filter 112 and configured to cooperate with a second pressure transmitter 142 and a third pressure transmitter 144 as described further herein to measure a pressure drop across the filter 112 for monitoring and optimization of filter performance.

A second portion of flow path 106, flow path 106b, may begin at the filter 112. As mentioned above, the second pressure transmitter 142 may be positioned within flow path 106b to facilitate measurement of the pressure drop across the filter 112. A flow transmitter 126 may be positioned within flow path 106b downstream of the filter 112 to measure the flow rate of the retentate from the filter 112. The flow transmitter 126 may be operably coupled with a flow controller 127, as shown by process control loop 117, which may control a flow control valve 146 according to input received from the flow transmitter 126. Process control loop 117 refers to all the dashed process control connections that interconnect flow controller 127, flow control valve 146, and flow transmitter 126. The flow control valve 146 may also be positioned within flow path 106b to prohibit or allow flow of retentate from the filter 112 to a first output 148 of the module 102 as desired for process configuration of the module 102. The flow control valve 146 may facilitate control of the flow of retentate as required by the status of the module 102 and/or the system 100 (FIG. 1) according to the flow controller 127. When the flow control valve 146 is open and flow path 106b is active, the retentate may exit the module 102 at the first output 148, ending flow path 106b. The flow rate of retentate through the flow control valve 146 may relate in part to the degree at which the flow control valve 146 is opened. For example, a fully opened valve may allow a maximum flow rate, while a half-opened valve may allow about a 50% flow rate. Varying degrees of openness of the valve 146 and corresponding flow rates may be used as desired for purposes of module operation. The first output 148 may be in fluid communication with a feed input of another module within the cTFF system 100 (FIG. 1), as described above, or facilitate the collection of retentate as product.

A ratio controller, such as gamma controller 180 discussed further herein, may generally regulate flow controller 127 of process control loop 117 for retentate flow path 106b based on flow controller 133 of process control loop 141 for filter flow path 108 as shown by process control loop 181 and described further herein.

A second portion of flow path 104, flow path 104b, may also begin at the filter 112. As mentioned above, the third pressure transmitter 144 may be positioned within flow path 104b to facilitate measurement of the pressure drop across the filter 112. A pressure control valve 150 may also be positioned within flow path 104b to improve the retentate flow control function as described above and described further herein under certain process conditions. A third flow transmitter 154 may be positioned between the filter 112 and the pressure control valve 150 to measure the flow rate of the permeate from the filter 112 to the permeate break tank 152. The pressure control valve 150 may facilitate control of the permeate pressure as required by the status of the module 102 and/or the system 100 (FIG. 1). When the pressure control valve 150 is open and flow path 104b is active, the permeate may enter the permeate break tank 152 as described further herein. In some embodiments, the pressure control valve 150 may be a passive control valve. The flow through the pressure control valve 150 may be determined by the overall mass balance of the system as described further herein. The permeate pressure upstream of the pressure control valve 150 may relate in part to the degree at which the flow control valve 150 is opened. For example, a fully opened valve may allow a minimum permeate pressure, while a half-opened valve may allow an elevated permeate pressure. Varying degrees of openness of the valve 150 and corresponding permeate pressures may be used as desired for purposes of module operation. The flow rate of flow path 104b, or the permeate flow path, therefore results from the overall mass balance around the filter 112. As such, any change to the flow rate within flow path 108 or flow path 106b results in a responsive change in flow rate within flow path 104b to maintain conservation of mass within the module 102.

In some situations, the flow rate within flow path 104b is too high relative to a target flow rate set with the gamma controller 180. The gamma controller 180 may attempt to compensate by further opening valve 146 to divert flow from flow path 104b to flow path 106. However, in some instances, the valve 146 cannot be opened any further (e.g., is already fully open). In this situation, permeate pressure may be applied where manual or automated adjustment of the valve 150 may be completed by a user or control system to move the valve 150 toward a closed position, changing the dynamics within the filter 112 and forcing more flow into flow path 106b, which allows the valve 146 to regain active control of the flow rate within flow path 104b as discussed further herein.

The permeate break tank 152 may receive permeate flow from the filter 112 as determined by the cooperation of the first flow control valve 146 and the pressure control valve 150. The permeate break tank 152 may serve to both collect permeate from the module 102 and be a reservoir to supply the permeate as diafiltration solution to an upstream module 102 of the cTFF system 100 (FIG. 1) as described above. Under ideal steady-state conditions, the level in the permeate break tank 152 may remain substantially stable as the amount of permeate that flows into the permeate break tank 152 may be substantially the same as the amount of diafilterant flowing out of the permeate break tank 152 into the next-supplied module. A level transmitter 156 may be configured to measure the amount of permeate present in the permeate break tank 152 and work in tandem with a level controller 157 to ensure said amount is within a threshold range. The threshold range of the permeate break tank 152 may facilitate inclusion of an air gap within the permeate break tank 152, allowing the break tank to absorb flow control disturbances and decoupling flow control between the modules 120. The permeate break tank 152 may further include a corresponding second vent 153 in fluid communication with ambient pressure to allow pressure to return to and remain at ambient pressure between modules 102, which may be further facilitated by the air gap, for the reasons provided above in relation to feed break tank 110.

A pump 131, such as a positive displacement pump, may be positioned downstream of the permeate break tank 152 to facilitate flow of the permeate from the permeate break tank 152 to the second output 160 of the module 102. The pump 131 may be operably coupled to a speed controller 155, which may further be operably coupled to the level transmitter 156 and the level controller 157 as shown by process control loop 159. Process control loop 159 refers to all the dashed process control connections that interconnect speed controller 155, level controller 157, and level transmitter 156. The speed controller 155 may adjust the speed of the pump 131 as desired per the measurements taken and provided by the level transmitter 156 to keep the permeate level of the permeate break tank 152 within the level threshold range as determined by the level controller 157. In other embodiments, a weight transmitter (not shown) may be operably coupled to the permeate break tank 152 to measure the contents of the permeate break tank 152 via weight in addition to or instead of level. The weight transmitter and the level transmitter may work in tandem or separately to measure the contents of the permeate break tank 152 in various embodiments. In some situations, if the level of permeate in the permeate break tank 152 exceeds a ceiling threshold amount, permeate may be drained to waste along flow path 104c, access to which may be facilitated by a valve 105. If the level of permeate in the permeate break tank 152 drops below a floor threshold amount, supplemental diafiltration buffer may be added along flow path 104d, access to which may be facilitated by a valve 107.

A valve 162 may be positioned downstream of the pump 131 along a flow pathway 104e. The valve 162 may be operational to allow or prohibit flow of permeate to the second output 160. The second output 160 may be in fluid communication with a permeate supply of an upstream module of the system 100 (FIG. 1) as discussed above. A control valve 164 may also be positioned downstream of the pump 131 along a flow pathway 1046f. The control valve 164 may be operational to allow or prohibit flow of permeate to waste 170 as discussed further herein. The control valve 164 may be operably coupled to a flow controller 166 and/or a flow transmitter 168 to measure and control the flow of permeate from the permeate break tank 152 to waste 170. The flow transmitter 168 may be operable to measure the flow rate of permeate between the permeate break tank 152 and the control valve 164, while the flow controller 166 operates the control valve 164 to maintain, decrease, or increase the flow rate as measured by the flow transmitter 168.

As discussed above, each module 102 may be manipulated to fulfill particular processes as desired via operation of a plurality of valves, as discussed above, which close and/or open the flow paths described herein as needed. A first pathway configuration that may be consistent with an spTFF process may include fluid flow directed through flow path 104a, flow path 108, and each of flow paths 104b and 106b as necessary, so that flow path 106a is closed in the first pathway configuration. A second pathway configuration that may be consistent with a CCBE-TFF process may include fluid flow directed through each of flow paths 104a, 106a, 108, and each of flow paths 104b and 106b as necessary. A third pathway configuration allowing substantial simultaneous CCBE-TFF and spTFF processes may include fluid flow directed through flow path 104a, flow path 106a, flow path 108, and each of flow paths 104b and 106b as necessary.

Control of the cTFF system 100 to maintain a steady-state within the system and facilitate stability and efficiency may rely at least in-part on monitoring and control of flow ratios within the system 100, which may be established based on the desired degree of solution/buffer exchange. The desired degree of solution/buffer exchange may depend on the type of process being implemented. For instance, some processes may require an exchange efficiency between solution and buffer of almost 100% (e.g., 99.996%). Other processes may require a lower exchange efficiency, such as 99%. Lower exchange efficiency requirements are also possible. As the number of CCBE stages increases within the cTFF system 100, the exchange efficiency may also increase, which may decrease the amount of diafiltration solution and/or buffer required.

The degree of buffer exchange required may be represented as an impurity removal value (derivation not shown). As used herein, “impurity” is being used generally to represent any species that is intended to be removed by the TFF diafiltration process. From this impurity removal value, the impurity removal factor (“a”) may be calculated as a function of CCBE stages present in a system using the equation below:

$$FR = \frac{{C}_{F}}{{C}_{N}} = \frac{{α}^{N + 1} - 1}{α - 1}$$

wherein:
FR=impurity removal value
C_{F}=concentration of component in feed
C_{N}=concentration of component in retentate from final stage
a=impurity removal factor
N=number of buffer exchange stages (modules)
   The flow ratio of exchange buffer to the feed to the CCBE section of the cTFF system may then be calculated from the impurity removal factor using the equation below:

$$α = \frac{{Q}_{DF} * S}{{Q}_{F}}$$

wherein:
a=impurity removal factor
Q_{DF}=flow rate of diafiltration buffer into the countercurrent system
Q_{F}=flow rate of the feed into the countercurrent system
S=sieving coefficient
   It is understood that for many, but not all, tangential flow filtration processes, the sieving coefficient for small readily permeable solutes is equal to or close to 1. In the five module cTFF system as described above, the impurity removal factor is calculated as the ratio of the diafiltration buffer flow rate entering module 102e divided by the flow rate of the product stream entering module 102b. For purposes of process control, stage removal factor (“T”) is introduced in the present disclosure. The stage removal factor (γ) may be a ratio between any two of the following three parameters: (i) the feed flow rate, e.g., as measured by flow transmitter 132, (ii) the permeate flow rate, and (iii) the retentate flow rate. The permeate flow rate and the retentate flow rate can be measured for each individual module using flow transmitters 154, 126 (FIG. 2), respectively, downstream of the filter as described above. One of the permeate flow rate and the retentate flow rate may further be calculated using at least two of flow transmitters 154, 126, and 132 (FIG. 2). For example, the permeate flow rate may be calculated by subtracting the retentate flow rate measured by flow transmitter 126 (FIG. 2) from the feed break tank flow rate measured by flow transmitter 132 (FIG. 2). Similarly, the retentate flow rate may be calculated by subtracting the permeate flow rate measured by flow transmitter 154 (FIG. 2) from the feed break tank flow rate measured by flow transmitter 126 (FIG. 2).

In a CCBE-TFF process where the retentate concentration exiting each module matches the concentration of the feed material entering the CCBE-TFF module, the numerical value of the stage removal factor (“y”) and the impurity removal factor (“a”) are equivalent. In modules for which a greater retentate concentration is desired, e.g., the final stage of the system, the numerical value of the stage removal factor (“y”) may be greater than the mpurity removal factor (“a”). In other words, the cTFF system may approach a steady state as the stage removal factor approaches the impurity removal factor. However, these values do not always need to be equivalent to maintain a steady state depending on the desired outcome of the cTFF system processes.

Referring again to FIG. 2, and as described above, gamma controller 180 is in operable communication with flow controller 133 and flow controller 127. As described above, the gamma controller is configured to operate flow controller 127 to adjust the flow rate of flow path 106b via flow control valve 146, and, by resultant mass balance, flow path 104b, which is based on the flow rate of flow path 108 as controlled by flow rate controller 133, so that a calculated stage removal factor of each module 102 approaches a predetermined target stage removal factor setpoint. The target stage removal factor setpoint may be determined according to process requirements and how module 102 is being used. For example, if module 102 is being operated as a spTFF module only, the stage removal factor (γ) setpoint may be established based on the degree of concentration required from module 102. If module 102 is being operated as a CCBE only module, the stage removal factor (γ) setpoint may be determined based on the desired exchange efficiency. For instance, in one exemplary non-limiting embodiment, if the stage removal factor (γ) were defined as the ratio of permeate flow rate to retentate flow rate, then the stage removal factor setpoint may be set to the impurity removal factor (α) needed to achieve the desired exchange efficiency, as calculated using the equations above and/or determined/confirmed experimentally. In a combined CCBE and additional concentration module, the stage removal factor (γ) setpoint may be set to a point that achieves both the desired amount of concentration and the desired exchange efficiency.

The predetermined target stage removal factor may be preprogrammed into the gamma controller 180, where the predetermined target stage removal factor is the stage removal factor at which the module maintains a steady state. In other words, the gamma controller 180 may be configured to maintain the module at a steady state by automatically maintaining a substantially constant stage removal factor at or near the predetermined target stage removal factor by automatically and individually adjusting the retentate pathway 106b via operation of the flow controllers 127 as described above. In this way, the gamma controller 180 keeps the ratio of feed flow rate, permeate flow rate, and/or retentate flow rate at a constant target steady state necessary to achieve process-specific objectives.

In some embodiments, the gamma controller 180 may also be configured to compensate for manual or automatic adjustment of pump 130 or related controllers and/or the flow control valve 146 in a manner similar to that described above. For example, if a user notices that the level within the feed break tank 110 is too high, a manual adjustment to the speed controller 134, the pump 130, and/or the flow controller 133 may be performed. With such adjustment, the calculated stage removal factor of the module 102 is altered. The gamma controller 180 may then operate the flow control valve 146 via flow controller 127 so that the calculated stage removal factor approaches the predetermined target stage removal factor to compensate for the manual adjustment. As such, the manual adjustments and resultant automatic adjustments may be performed without requiring shut down of the module 102 or system 100 (FIG. 1).

In some embodiments, the gamma controller 180 may be configured to automatically adjust the flow control valve 146 according to the setpoint target of flow controller 133 of flow path 108. As described above, the setpoint target of flow controller 133 is adjusted according to the level of the feed break tank 110 as measured by level transmitter 136. For example, if the level transmitter 136 measures that the level within the feed break tank 110 is too high according to the level threshold of the level controller 137, the level controller 137 may communicate this the flow controller 133. Flow controller 133 may adjust the speed of the pump 130 via speed controller 134 in response to adjust the level of the mixture in the feed break tank 110. With such adjustment, the calculated stage removal factor of the module 102 is altered. The gamma controller 180 may then operate the flow control valve 146 via flow controller 122 so that the calculated stage removal factor approaches the predetermined target stage removal factor to compensate for the adjustment.

In a cTFF system similar to cTFF system 100 illustrated in FIG. 1, the secondary concentration process of the final modules, such as fifth module 102e, occurs by setting the target stage removal factor at a higher value than the target stage removal factor of intermediate modules 102b, 102c, and 102d. For example, while the stage removal factor and the flow removal factor for each of modules 102b, 102c, and 102d may be substantially equal, the stage removal factor for module 102e may be greater than the flow removal factor. This is because the retentate of module 102e, or, in systems having more than five modules, the final module, retentate is collected as a product. The permeate of the final module is split between a small waste stream, e.g., via flow path 104f, and the permeate supply of the immediately preceding module, e.g., via flow path 104e. The small waste stream removes excess permeate resulting from the secondary concentration of the final module, facilitated by the higher predetermined target stage removal factor. This translates to cTFF systems having a fewer or greater number of modules, in which the final module has a higher stage removal factor than intermediate modules.

As previously mentioned, a feed supply 103 to the entire cTFF system 100 may be provided to the feed supply of the first module 102a; more specifically, the feed supply 103 may be provided to flow path 106a of the first module 102a. A diafiltration buffer supply 111 to the entire cTFF system 100 may be supplied to the exchange buffer or permeate supply of the last module 102e and, more specifically, to flow path 104a. This diafiltration buffer supply may comprise the buffer that is desired to be exchanged with the buffer currently present in the feed supply. Finished product 109 for the entire cTFF system 100 may be collected from flow path 106b of the last module 102e.

Steady state operation of each module 102 may be governed and generally controlled by the break tank level controllers 137 and 157 and gamma controller 180. The maintenance of steady state operation within each module 102 of the system 100 (FIG. 1) facilitates steady state operation of the overall system 100 (FIG. 1). Due to the interconnection of the modules 102 within a system 100 as described and illustrated above in relation to FIG. 1, alteration of a total flow rate, or average flow rate through each of the flow paths 104a, 106a, 108, 104b, and/or 106b, of a module 102 may result in alteration of a total flow rate of the remaining modules within the system 100.

In some cTFF systems, filters may exhibit differing filtration rates across different stages within the system. Conventionally, for single stage spTFF systems, the differing filtration rates may be compensated for by altering the total flow rate within the individual stage, e.g., running the process faster or slower by altering the flow rate within the stage to achieve the desired degree of concentration. However, in the cTFF system 100 as described herein, the flow rate cannot be altered to adjust filtration rates, as such disruption in flow rate at one stage (e.g., a stage operated by module 102b) will disrupt the flow rate of the other stages (e.g., stages operated by modules 102a, 102c, 102d, 102e), which disrupts steady state operation.

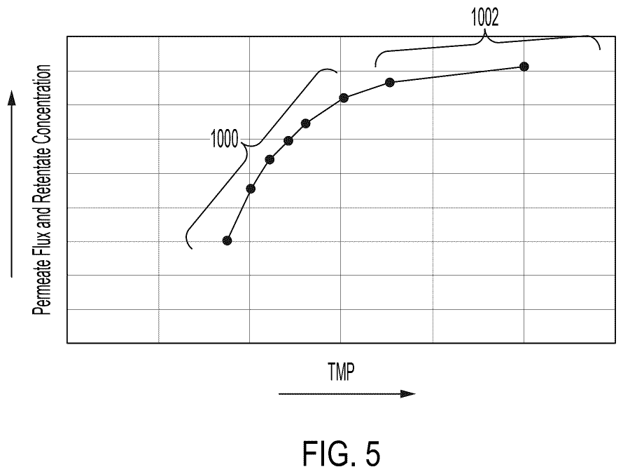

In view of the above and referring additionally to FIG. 5, the filter 112 of each module 102b is operated at an operation pressure level within a region of pressure dependence, for example, region 1000, where an increase in feed flow pressure (i.e., flow pressure measured by pressure transmitter 138) increases the filtration rate while a decrease in operation flow pressure decreases the filtration rate. For the level controllers, the flow controllers, and the gamma controller to be successful in maintaining steady state, the transmembrane pressure changes that result from controller action must impact the filtration rate, or permeate flux, without altering the flow rate in a manner that will disrupt the steady state operation of the entire system 100. A region of less pressure dependence is illustrated at region 1002 of FIG. 5. In yet other embodiments, parameters such as surface area of the filter or configuration of surface area of the filter may be manipulated at an individual stage level to affect filtration rate of a specific stage without disrupting the remaining stages or the overall system.

Generally, product collected during start-up and shut-down of continuous systems may not meet concentration or buffer exchange efficiency requirements, and such product collected during start-up or shut-down is discarded. Specific procedures may be followed to mitigate or eliminate these losses.

For example, when the system is being operated as a diafiltration system, the system is generally provided a feed supply of material comprising a solute of interest suspended in a starting solution matrix. As in any diafiltration operation, the goal of the system is to transfer the solute of interest from the starting solution matrix into an exchange buffer. In such a diafiltration system, the filters of the system may be flushed with the target exchange buffer solution prior to introducing the feed supply of material to be filtered to the system. All material collected from initial start-up to steady-state will then exceed the desired impurity removal factor as material is being overdiluted by exchange buffer already present in the system until steady-state is achieved. Since an excess of exchange buffer is typically not a cause for material rejection, the material collected from initial start-up to steady-state need not be discarded, thus reducing waste.

With respect to concentration, material collected during start-up may be less concentrated than required by process requirements. In order to compensate for this, the concentration during steady-state operation may be set to a level slightly higher than process requirements, such that combination of (i) the less-concentrated-than-required product collected during startup and (ii) the more-concentrated-than-required product collected during steady state will, together, meet the concentration specified by process requirements. Since the time required to bring the system to a steady state may be predicted mathematically and/or experimentally, and the total amount of product to be processed may be known in advance, the amount by which the steady-state concentration must exceed process requirements may be calculated based on overall mass balance. In this way, product collected during startup may not need to be discarded to waste.

### EXAMPLES

### Example 1

Operating targets for a test cTFF system were selected according to Table 1 below:

TABLE 1
Example Operating Parameter Targets

| Parameter | Units | Target |
|---|---|---|
| Feed Concentration | g/L | 100 |
| Surface Area | m\hat{ }2/stage | 1 × 0.24 |
| # of stages | n/a | 3 |
| Alpha | n/a | 7.115 |
| Crossflow Rate (Flux) | mL/min (LMM) | 144.0 (0.6) |
| Feed/Retentate | mL/min | 17.7 |
| Diafiltration Buffer/ | mL/min | 126.3 |
| Permeate | | |

Each of the tested stages, consistent with stages two through four as discussed above in relation to system 100, were configured for CCBE processes. The feed material included a 107 g/L mAb in an aqueous buffering solution with higher conductivity. This material was prepared using a standard single module spTFF configuration prior to use in this Example 1. The following events occurred at the given time points: at 0 minutes, a buffer flush was performed; at 9 minutes, the processing began with introduction of mAb feed material; at 320 minutes, the processing ended with a second buffer flush; at 330 minutes, a water flush was performed; at 340 minutes, a cleaning flush was performed; and at 350 minutes, shut-down of the test cTFF system was completed.

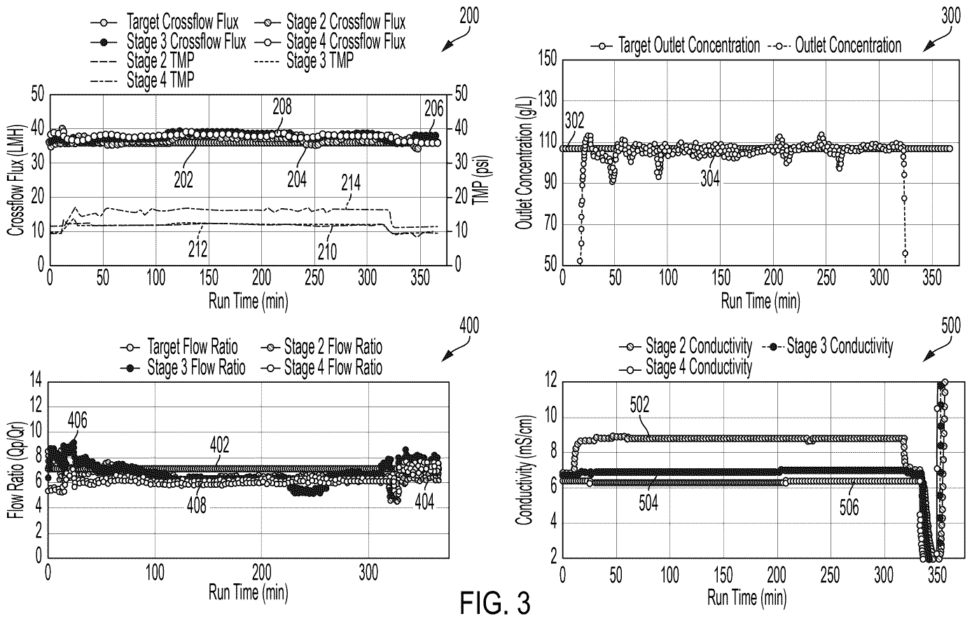

FIG. 3 illustrates the parameters monitored to assess steady-state operation and the measurement of said parameters over the time of the experimental operation. Image 200 illustrates the crossflow flux and transmembrane pressure (i.e., the difference between the average feed/retentate-side pressure and the average permeate side pressure across the filter) for each stage over run time of each stage, wherein line 202 illustrates the target crossflow flux, line 204 illustrates the crossflow flux of stage two, line 206 illustrates the crossflow flux of stage three, and line 208 illustrates the crossflow flux of stage four. Line 210 illustrates the transmembrane pressure of stage two, line 212 illustrates the transmembrane pressure of stage three, and line 214 illustrates the transmembrane pressure of stage four.

Image 300 illustrates the outlet concentration in g/L as compared to the target outlet concentration, wherein line 302 illustrates the target outlet concentration and line 304 illustrates the achieved outlet concentration. Image 400 illustrates the flow ratio, or ratio of the permeate flow rate to the retentate flow rate, for each stage, wherein line 402 illustrates the target flow ratio, line 404 illustrates the flow ratio of stage two, line 406 illustrates the flow ratio of stage three, and line 408 illustrates the flow ratio of stage four. Image 500 illustrates the conductivity of each stage, wherein line 502 illustrates the conductivity of stage two, line 504 illustrates the conductivity stage three, and line 506 illustrates the conductivity of stage four

Stable steady-state operation was achieved for over 5 and a half hours, wherein only minor flow rate adjustments were needed every 30-60 minutes. As shown in images 200 and 400, the crossflow rate and flow ratios remained stable near target values for the duration of the run. The conductivity dropped across stages two through four as shown in image 500, which was expected to demonstrate the occurrence of buffer exchange. At the conclusion of stage four, retentate product was collected with an overall concentration of 108 g/L, including pre-steady state and post-steady state material that was pooled with the steady-state retentate, demonstrating that the feed concentration was similar to the outlet concentration across the three CCBE modules as expected for modules operating in buffer exchange mode only.

### Example 2

Operating targets for a test cTFF system were selected according to Table 2 below:

TABLE 2
Operating Parameter Targets

| Parameter | Units | Target |
|---|---|---|
| Feed Concentration | g/L | 250 |
| Surface Area | m\hat{ }2/stage | 1 × 0.24 |
| # of stages | n/a | 1 |
| Alpha | n/a | 7.115 |
| Crossflow Rate (Flux) | mL/min (LMM) | 72.0 (0.3) |
| Feed/Retentate | mL/min | 8.9 |
| Diafiltration Buffer | mL/min | 63.1 |
| Permeate | mL/min | 67.3 |

The tested stage, consistent with stage five as discussed above in relation to system 100, was configured for simultaneous CCBE and spTFF (i.e., secondary concentration processes). The feed material included a 108 g/L mAb in an aqueous buffering solution. The following events occurred at the given time points: at 0 minutes, a buffer flush was performed; at 1 minute, the processing began with introduction of mAb feed material; at 170 minutes, the processing ended with a second buffer flush; at 188 minutes, a water flush was performed; at 200 minutes, a cleaning flush was performed; and at 210 minutes, shut-down of the test cTFF system was completed.

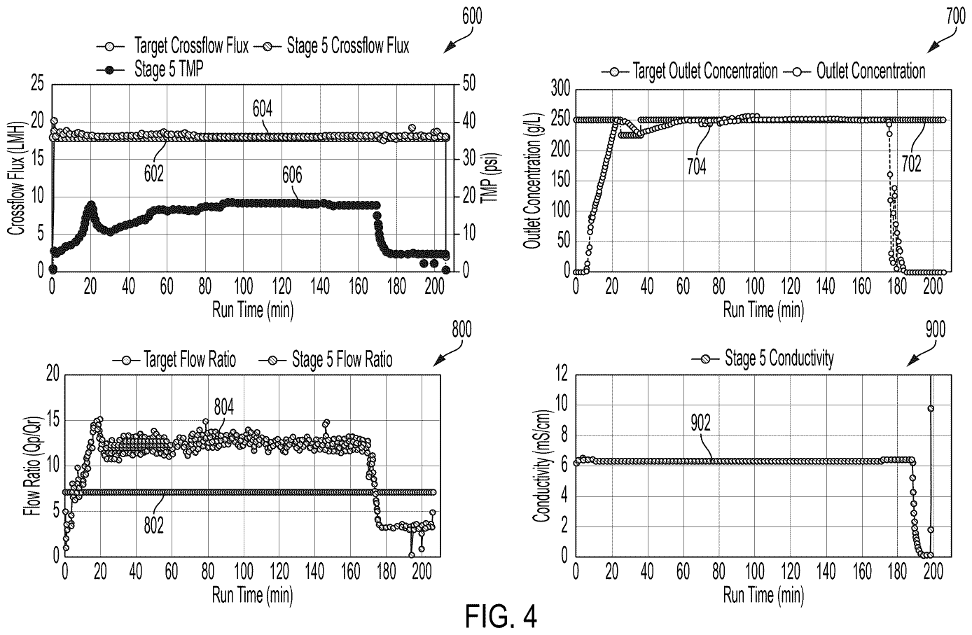

FIG. 4 illustrates the parameters monitored to assess steady-state operation and the measurement of said parameters over the time of the experimental operation. Image 600 illustrates the crossflow flux and transmembrane pressure (i.e., the difference between the average feed/retentate-side pressure and the average permeate-side pressure across the filter) for the stage over run time of the stage, wherein line 602 illustrates the target crossflow flux and line 604 illustrates the crossflow flux of stage five. Line 606 illustrates the transmembrane pressure of stage five.

Image 700 illustrates the outlet concentration in g/L as compared to the target outlet concentration, wherein line 702 illustrates the target outlet concentration and line 704 illustrates the achieved outlet concentration. Image 800 illustrates the flow ratio of stage five as compared to the target flow ratio, or ratio of the crossflow flow rate to the retentate flow rate, wherein line 802 illustrates the target flow ratio for the buffer exchange and line 804 illustrates the flow ratio of stage five. The flow ratio is higher than the target because this is a combined CCBE and spTFF stage, as previously explained. Image 900 illustrates the conductivity of stage five, wherein line 902 illustrates the conductivity of stage five.

Stable steady-state operation was achieved for nearly three hours. Only minor flow rate adjustments were needed every 30-60 minutes. As shown in images 600 and 800, the crossflow rate, flow ratio, concentration, and conductivity were stable for the duration of the run.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A tangential flow filtration module, the module comprising:
a flow supply comprising a module exchange buffer supply and a module feed supply;
a feed break tank positioned downstream of the flow supply, the feed break tank including a powered agitator; and
a first filter positioned downstream of the feed break tank.

2. The tangential flow filtration module of claim 1, further comprising a feed pump positioned between the feed break tank and the first filter, the feed pump configured to control a flow rate of a flow between the feed break tank and the first filter.

3. The tangential flow filtration module of claim 1, wherein operation of the powered agitator is configured to create a homogenous solution.

4. The tangential flow filtration module of claim 1, wherein the feed break tank defines an air gap.

5. The tangential flow filtration module of claim 1, wherein the feed break tank defines a vent in fluid communication with ambient pressure.

6. The tangential flow filtration module of claim 1, further comprising a permeate break tank positioned downstream of the first filter.

7. The tangential flow filtration module of claim 1, wherein the module exchange buffer supply is comprised of permeate of a second filter positioned downstream of the first filter, a feed supply of the second filter comprising retentate of the first filter.

8. The tangential flow filtration module of claim 1, wherein the module feed supply is comprised of retentate of a third filter positioned upstream of the first filter.

9. A tangential flow filtration module, the module comprising:
a flow supply comprising a module exchange buffer supply and a module feed supply;
a first filter positioned downstream of the flow supply and having two outputs, including a permeate output and a retentate output; and
a permeate break tank positioned downstream of the filter and supplied by the permeate output of the filter.

10. The tangential flow filtration module of claim 9, further comprising a feed break tank positioned between the flow supply and the filter.

11. The tangential flow filtration module of claim 9, wherein an interior of the permeate break tank defines an air gap.

12. The tangential flow filtration module of claim 9, wherein the permeate break tank includes a vent in fluid communication with ambient pressure.

13. The tangential flow filtration module of claim 9, further comprising a valve positioned between the first filter and the permeate break tank, the valve configured to control permeate pressure on the permeate side of the first filter.

14. The tangential flow filtration module of claim 9, wherein the permeate break tank supplies a second filter positioned upstream of the feed supply.

15. The tangential flow filtration module of claim 14, wherein the feed supply is comprised of retentate of the second filter.

16. The tangential flow filtration module of claim 9, wherein the module exchange buffer supply is comprised of permeate of a third filter positioned downstream of the first filter, a feed supply of the third filter comprising retentate of the first filter.

17. The tangential flow filtration module of claim 9, further comprising at least one valve, wherein operation of the valve is configured to change:
a configuration of the tangential flow filtration module from a first flow path configuration to a second flow path configuration; or
a configuration of the tangential flow filtration module from the second flow path configuration to a first flow path configuration;
wherein the first flow configuration is a counter-current buffer exchange flow path configuration; and
wherein the second flow configuration is a single-pass tangential flow filtration flow path configuration.

18. A tangential flow filtration system, the tangential flow filtration system comprising:
a plurality of individual modules, each of said individual modules configured to perform a process associated with tangential flow filtration, wherein each individual module includes:
a plurality of valves, wherein actuation of the plurality of valves is configured to alter a flow path of the corresponding individual module; and
a control system configured to:
calculate a current stage removal factor for the individual module, the current stage removal factor being a ratio between any two of a permeate flow rate, a feed flow rate, and a retentate flow rate for the individual module; and
automatically operate the plurality of valves to alter the flow path so that the current stage removal factor for the individual module approaches a target stage removal factor.

19. The tangential flow filtration system of claim 18, wherein the plurality of individual modules includes at least five modules.

20. The tangential flow filtration system of claim 18, wherein a last individual module of the plurality of individual modules has a different target stage removal factor than at least one other individual module of the plurality of individual modules.

21. The tangential flow filtration system of claim 18, wherein the control system is configured to maintain the tangential flow filtration system in a steady state in which the current stage removal factor approaches the target stage removal factor.

22. The tangential flow filtration system of claim 21, wherein:
the system is configured to allow a user to adjust, when the tangential flow filtration system is in the steady state, at least one valve of the plurality of valves in a way that causes the current stage removal factor to diverge from the target stage removal factor; and
the control system is configured to automatically operate remaining valves of the plurality of valves to compensate for the user's adjustment such that the current stage removal factor again approaches the target stage removal factor after the user's adjustment.

23. The tangential flow filtration system of claim 21, wherein each of the plurality of individual modules comprises:
a feed break tank positioned downstream of a flow supply and upstream of a filter for the individual module, the flow supply comprising a module feed supply and a module exchange buffer supply; and
a permeate break tank positioned downstream of the filter;
wherein a first flow rate output of the feed break tank and a second flow rate output of the permeate break tank are individually adjustable during operation of the tangential flow filtration system; and
wherein the control system is configured to maintain the tangential flow filtration system in a steady state by automatically maintaining a substantially constant stage removal factor during adjustment of either of the first flow rate output or the second flow rate output.

24. The tangential flow filtration system of claim 23, wherein the control system is further configured to maintain a constant level within the feed break tank and a constant level within the permeate break tank.

25. A tangential flow filtration system, the system comprising:
a plurality of modules, each module comprising:
a module flow supply;
a filter positioned downstream of the module flow supply; and
at least one of:
a feed break tank positioned between the module flow supply and the filter; and
a permeate break tank positioned downstream of the filter.

26. The tangential flow filtration system of claim 25, wherein each module has at least one of a first configuration corresponding to a single-pass tangential flow filtration (“spTFF”) process, a second configuration corresponding to a counter-current buffer exchange tangential flow filtration (“CCBE-TFF”) process, and a third configuration corresponding to a combined spTFF and CCBE-TFF process.

27. The tangential flow filtration system of claim 26, wherein each module of the plurality of modules includes a plurality of valves so that each module of the plurality of modules is capable of selectively switching from the first configuration to at least one of the second configuration and the third configuration, selectively switching from the second configuration to at least one of the first configuration and the third configuration, and selectively switching from the third configuration to at least one of the first configuration and the second configuration.

28. The tangential flow filtration system of claim 26, wherein a first module of the plurality of modules is in the first configuration and a second module of the plurality of modules is in the second configuration.

29. The tangential flow filtration system of claim 28, wherein a first plurality of modules including the first module are in the first configuration and a second plurality of modules including the second module are in the second configuration.

30. The tangential flow filtration system of claim 26, wherein a last module of the plurality of modules is operated in the third configuration.

31. The tangential flow filtration system of claim 30, wherein at least some permeate from the last module is supplied to a module exchange buffer supply for another module upstream to the last module, and at least some permeate from the last module is sent to waste.

32. The tangential flow filtration system of claim 25, wherein each module of the plurality of modules includes a retentate flow path and a permeate flow path, and wherein the permeate break tank is positioned along the permeate flow path.

33. The tangential flow filtration system of claim 25, further comprising at least five modules.

34. The tangential flow filtration system of claim 25, wherein a first module of the plurality of modules includes a system feed supply, and a last module of the plurality of modules includes a system buffer exchange supply.

35. The tangential flow filtration system of claim 25, wherein the system is configured to operate as a diafiltration system that transfers a solute of interest from within a feed supply from a starting solution matrix into an exchange buffer, and wherein the system is configured to flush the filter of each modules with the exchange buffer before starting to filter the feed supply.

36. The tangential flow filtration system of claim 25, wherein the system is configured to compensate for outputting product during system start-up with a concentration that is lower than process requirements by outputting product during steady-state with a concentration that is higher than process requirements, such that a mixture of product output during start-up and product output during steady-state has a concentration that meets the process requirements.
